(19) United States
(12) Patent Application Publication
(10) Pub. No.: US 2004/0149090 A1
(43) Pub. Date: Aug. 5, 2004

(54) Water pump removal tool

(75) Inventor: Michael L. Whitehead, Clarinda, IA (US)

Correspondence Address: BANNER & WITCOFF, LTD., TEN SOUTH WACKER DRIVE, SUITE 3000, CHICAGO, IL, 60606, US

(73) Assignee: Lisle Corporation, Clarinda, IA

(21) Appl. No.: 10/354,672

(22) Filed: Jan. 30, 2003

(51) Int. Cl. B25B 13/56

(52) U.S. Cl. 81/176.15

(57) ABSTRACT

A tool for removal of a vehicle water pump, includes a cylindrical metal hollow member with a transverse butt plate welded at one end and teeth formed at the other end to engage tangs on a water pump so that the tool may be rotated to release a water pump from a housing. The teeth are especially constructed to ensure proper engagement thereof with the water pump tangs to effect removal from the water pump housing.

### BACKGROUND OF THE INVENTION

In a principal aspect the present invention relates to a tool for removal of a water pump from a housing in a motor vehicle.

Various motor vehicles mount the water pump associated with the engine cooling system within a housing in the vehicle wherein the water pump is retained in the housing by means of locking tabs on the pump. The water pump locking tabs are fitted into slots and the pump is then rotated to engage the pump tabs with the edge of the housing slots and thereby retain the pump within the housing. A pulley or belt which drives the water pump drives the pump in a sense the same as that of the sense or direction of rotation required to engage the pump locking tabs to hold the pump in the housing slots. Thus, to remove the pump from the housing it is necessary to reverse the direction of movement of the axial drive shaft of the water pump from the direction effected by a belt or other means that drives the pump.

Heretofore, the release of the water pump from its housing, particularly in certain model vehicles, has been effected by means of a cylindrical water pump removal tool. Such a tool is typically required for maintenance on the 4.6 liter engines used in 1995 to 1997 Cadillac Model DeVille, Eldorado and Seville vehicles and also for the General Motors 4.0 liter engine used in the 1995 through 1998 Oldsmobile Aurora vehicles. The cylindrical tubular tool is placed about the water pump and caused to engage tangs on the pump to thereby effect desired counter-rotation of the pump in the housing. The tool includes straight-edged teeth which engage the tangs of the water pump and thereby effect potential removal of the water pump by counter-rotation of the pump.

While such a tool is useful, one of the problems often confronted results because the water pump or its housing is corroded and thus is very difficult to remove. As a consequence, the straight-edged tool teeth will slip and become disengaged from the water pump tangs. Consequently, it is difficult to obtain a “purchase” on the water pump and effect the removal of the water pump assembly from the housing for the pump. As a result, there has developed a need for an improved water pump removal tool.

### SUMMARY OF THE INVENTION

Briefly the present invention comprises a tool for removal of a vehicle water pump from a pump housing in the engine compartment of the vehicle. The tool comprises a hollow metal, uniform diameter cylinder having an outside end with a transverse butt plate affixed thereto. The butt plate includes a socket opening along the centerline axis of the cylinder to enable a socket wrench to engage the opening with a lug and thereby effect rotation of the tool. The opposite or inside end of the tool includes a series of six equally spaced, double sided teeth. Each tooth comprises an arcuate sector of the cylinder extending in the range of 15% to 20% of the circumference of the cylinder, and the teeth are identical. Each tooth has a flat axially extending side and an inwardly inclined side. The pairs of sides forming the teeth are joined by a transverse, straight side edge. The inclined side is canted inwardly from the transverse edge or side at a 45° angle to form a tooth which will appropriately engage the water pump, and more particularly, tangs on the outside of the water pump to thereby effect removal of the pump from the water pump housing upon counter-rotation of the pump in its housing.

Thus, it is an object of the invention to provide an improved tool for removal of a vehicle water pump.

It is a further object of the invention to provide an improved tool for removal of a water pump wherein the removal tool is economical, easy to use, rugged and is useful for a wide variety of General Motors vehicle engines.

A further object of the invention is to provide a water pump removal tool which includes an improved set of teeth to effect positive engagement of the tool with a water pump and which is useful, particularly if the water pump is corroded in place in the water pump housing.

These and other objects, advantages and features of the invention will be set forth in a detailed description which follows:

### BRIEF DESCRIPTION OF THE DRAWING

In the detailed description which follows, reference will be made to the drawing comprised of the following figures:

FIG. 1 is a side elevation of the tool of the invention;

FIG. 2 is an end view of the tool of FIG. 1 as viewed from the active or inside end of the tool;

FIG. 3 is an isometric view of the tool of the invention; and

FIG. 4 is an isometric view showing the method of use of the tool of the invention.

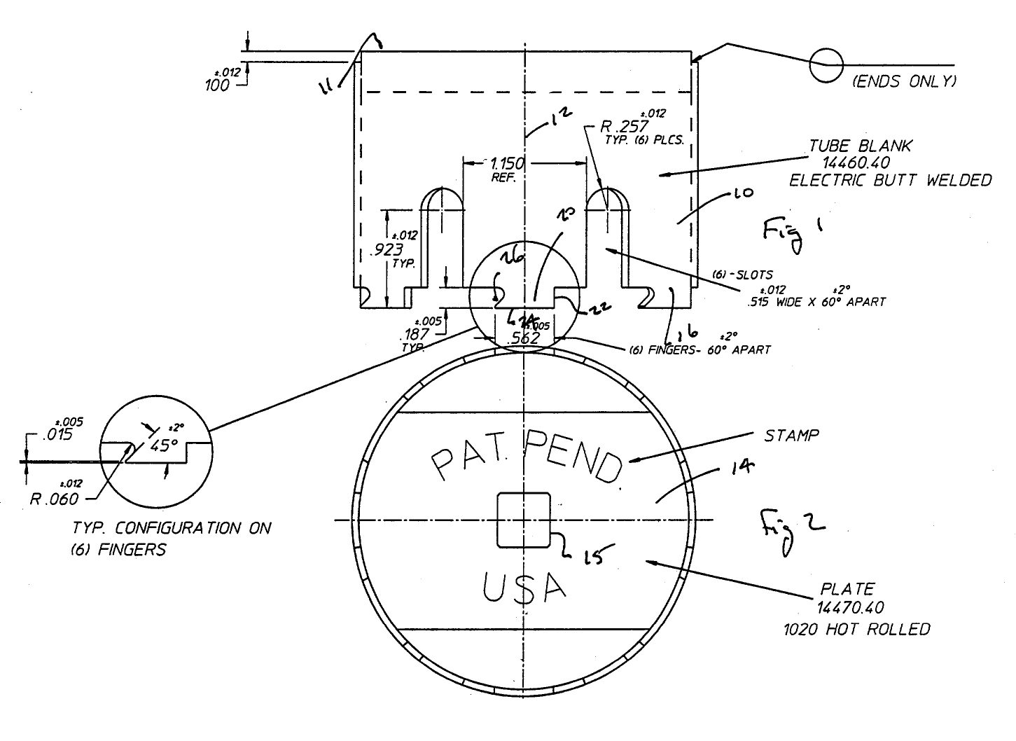

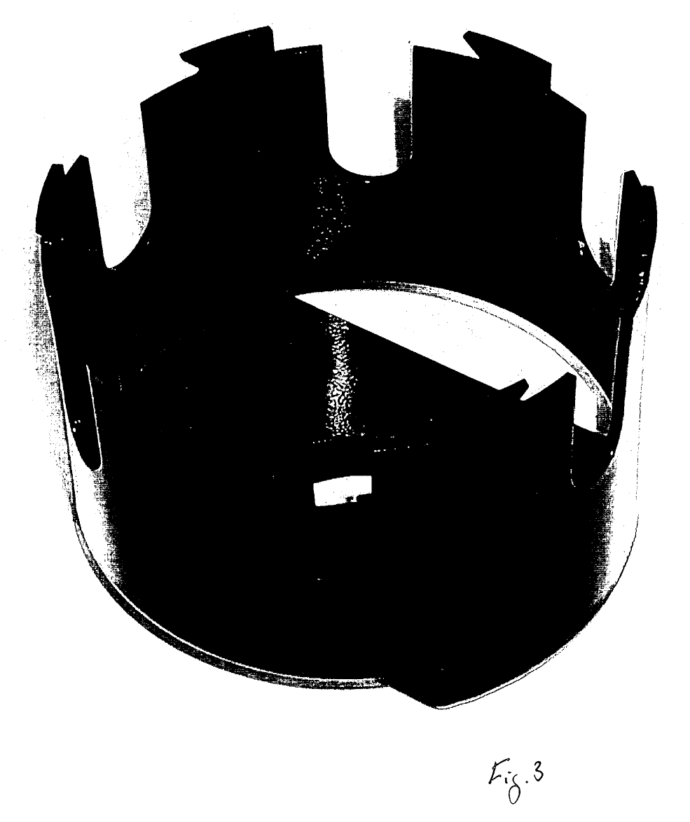

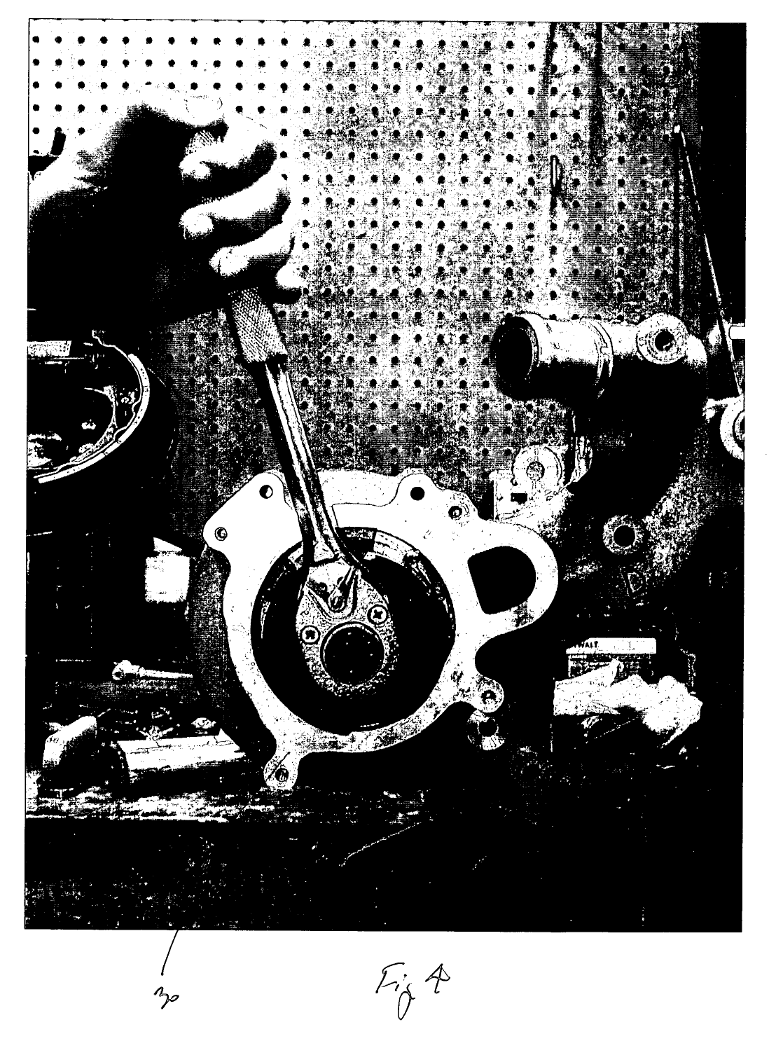

### DESCRIPTION OF THE PREFERRED EMBODIMENT

Referring to the figures, the tool of the invention comprises a metal cylinder having a uniform diameter. Thus, the cylinder 10 includes a centerline axis 12 which comprises an axis of rotation for the cylinder 10. The cylinder 10 is typically a case-hardened steel material. A flat butt plate 14 is welded onto the outside end of the cylinder 10 transverse to the axis 12. The inside end 16 of the tool comprises a set of six identically shaped, axially projecting teeth 20. Each tooth 20 comprises a sector of the cylinder 10 in the range of 15° to 20° of the circumferential extent of the cylinder 10 forming the tool. Thus each tooth 20 includes a first, straight, axial extending side 22 which is parallel to the axis 12, a second, straight, transverse side or edge 24 which forms a right angle with the first side or edge 22, and a third, straight, edge or side 26 which forms an angle of about 45° with respect to the transverse side or edge 24.

The six teeth or fingers 20 are arrayed about the periphery of the cylinder 10 in a manner whereby the teeth 20 are equally spaced thus having a 60° separation of the centerline of each tooth 20. The third edge 26 and the second edge 24 together form a pointed tooth end 33 which extends in the direction of clockwise movement of the tool for engagement with tangs (not shown) on a water pump 41 retained within a water pump housing. For example, the tool as depicted in FIG. 4 may be inserted about the periphery of a water pump 41 within the housing 30 and rotated in the clockwise direction to engage tangs on the water pump 41 within the housing 30 to thereby effect removal of the pump 41 upon appropriate rotation and withdrawal thereof from the housing 30.

In a preferred embodiment the diameter of the cylinder 10 is in the range of about 3¼-4 inches. Each of the teeth 20 has a circumferential extent in the range of 15° to 20° of the circumference of the cylinder 10 and a depth in the range of about 0.18 to 0.2 inches. The butt plate 14 is welded or permanently affixed to the outside end 11 of the cylinder 10. The inside end 16 is spaced from the outside end an adequate distance so that the teeth 20 may be appropriately engaged with tangs associated with a water pump 41. Thus the longitudinal extent of the cylindrical tubular member 10 will be in the range of 2 to 3 inches. The butt plate 14 includes a center socket opening 15 for receipt of a socket such as depicted in FIG. 4. An important aspect of the invention is the pointed or angled tooth end 33 formed by the transverse edge 24 and the third edge 26. This ensures that the water pump 41 may be gripped by the tool and properly removed. Another important feature of the invention is the utilization of a separate butt plate 14 and cylinder 10. The parts are separately formed and attached together by means of welding or the like. This makes the tool very effective and yet inexpensive. Thus, while there has been set forth a preferred body of the invention, it is to be understood that the invention is limited only by the following claims and equivalents thereof.

What is claimed is:

1. A tool for removal of a vehicle water pump from a pump housing, said pump housing including peripheral, spaced outside tangs, said tool comprising, in combination:
a hollow metal, uniform diameter cylinder having a center line axis of rotation, an outside end transverse to the axis, and an inside pump engagement end, the pump engagement end including six pump engagement teeth, said teeth equally spaced from each other about the circumference of the cylinder, each tooth having a substantially identical shape and comprising a sector of the cylinder, as viewed from the outside end toward the inside end each tooth extending in the range of about 15 to 20 degrees of the circumference of the cylinder, each tooth including a first edge parallel to the axis, a second edge perpendicular to the first edge, and a third edge formed at an angle of approximately 45 degrees from the second edge to define a pointed drive tab for engaging a tang of a water pump when the cylinder is placed over the outer periphery of the pump and rotated clockwise relative to the axis; and
a flat butt plate affixed to the outside end said plate including a center, axial, socket drive opening.
